(19) United States
(12) Patent Application Publication
(10) Pub. No.: US 2025/0353405 A1
(43) Pub. Date: Nov. 20, 2025

(54) SYSTEM AND MOUNTING ARRANGEMENTS FOR ACCESSING MACHINE SEAT CONTROLS

(71) Applicant: Caterpillar Inc., Peoria, IL (US)

(72) Inventors: Gurbaz Singh, Chandigarh (IN); Manoj Kumar, Bangalore (IN); Jason Rex Dare, Peoria, IL (US); Lalitha Meghana Vangala, Eluru (IN)

(73) Assignee: Caterpillar Inc., Peoria, IL (US)

(21) Appl. No.: 18/663,143

(22) Filed: May 14, 2024

(51) Int. Cl. B60N 2/02

(52) U.S. Cl. CPC B60N 2/0228

(57) ABSTRACT

System and mounting arrangements for accessing machine seat controls in machines is disclosed. The system comprises a control unit configured for machine seat adjustment. The control unit comprises a front casing and rear casing. The front casing comprises machine seat controls and the rear casing is detachably affixed to the front casing. The system further comprises a holder. The holder comprises a body defining a closed end, an open end, and a cavity extending from the closed end to the open end. The cavity is configured to receive at least a portion of the rear casing of the control unit. In addition, the system comprises an extension cable coupled with the control unit and configured to be extensible along with the control unit when the portion of the rear casing is removed from the cavity and the control unit is displaced away from the holder.

### TECHNICAL FIELD

The present disclosure relates in general to machine seat controls in heavy-duty machines.

### BACKGROUND

Conventionally, machine seat controls provided in heavy-duty machines including, but not limited to, loaders, bulldozers, and excavators, are immovably affixed to an operator seat and are often difficult to access for an operator. Moreover, a placement of the machines seat controls in such machines may be such that the operator may struggle to operate the machine seat controls comfortably and accurately when required. Hence, there is a need for the machine seat controls to be provided in an ergonomically convenient manner to the operator in such machines.

UK Patent No. GB2334673A relates to a remote control unit of a vehicle seat. The remote control unit can be stowed by clipping it to a bracket. The bracket is mounted in a suitable position in the cab so that the remote control unit can be readily removed from the bracket by a seated driver but so that the remote control unit and the bracket do not interfere with normal driving or obstruct dashboard space required for more frequently used buttons. However, in an event of accidental breakage or loosening of the clipping of the bracket, it may be necessary to protect the exposed remote control unit from slippage from the bracket and consequent damage.

### SUMMARY

In an aspect of the present disclosure, a system for accessing one or more machine seat controls in a machine is disclosed. The system includes a control unit configured for machine seat adjustment. The control unit includes a front casing and rear casing. The front casing includes the machine seat controls. The rear casing is detachably affixed to the front casing. The system also includes a holder defining a body having a closed end, an open end, and a cavity extending from the closed end to the open end. The cavity is configured to receive at least a portion of the rear casing of the control unit. In addition, the system includes an extension cable coupled with the control unit. The extension cable is configured to be extensible along with the control unit when the portion of the rear casing is removed from the cavity and the control unit is displaced away from the holder.

In another aspect of the present disclosure, a holder for a control unit configured for machine seat adjustment is disclosed. The holder defines a body having a closed end, an open end, and a cavity extending from the closed end to the open end. The cavity is configured to receive at least a portion of the control unit. The cavity defines a rearward portion proximate the closed end. The rearward portion includes at least one holding surface and at least one fastening element affixed to the at least one holding surface. The fastening element is configured for detachable contact with a corresponding fastening element provided on the portion of the control unit.

In yet another aspect of the present disclosure, a control unit configured for machine seat adjustment is disclosed. The control unit includes a front casing and a rear casing. The front casing includes at least one opening and at least one machine seat control provided in the at least one opening. The rear casing is detachably affixed to the front casing. A portion of the rear casing is configured to be accommodated in a corresponding cavity of a control unit holder. The portion of the rear casing includes at least one docking surface and at least one fastening element affixed to the at least one docking surface. The at least one fastening element is configured for detachable contact with a corresponding fastening element provided in the cavity of the control unit holder.

### BRIEF DESCRIPTION OF DRAWINGS

FIG. 1 is an exemplary illustration of an interior of a machine including a machine seat and a system for accessing one or more machine seat controls, in accordance with some embodiments of the present disclosure;

FIGS. 2-3 are exemplary illustrations of a control unit of the system of FIG. 1 having machine seat controls, in accordance with some embodiments of the present disclosure;

FIGS. 4-8, are exemplary illustrations of a holder of the system of FIG. 1 for accommodating the control unit of FIGS. 2-3, in accordance with some embodiments of the present disclosure;

FIGS. 9-10 are exemplary illustrations of the holder of the system of FIG. 1, in accordance with other embodiments of the present disclosure;

FIG. 11 is an exemplary illustration of extension cable coupled to the control unit of FIGS. 2-3, in accordance with some embodiments of the present disclosure; and

FIGS. 12-13 are exemplary illustrations of displacing the control unit of FIGS. 2-3 from the holder of FIGS. 4-8 provided on the machine seat of FIG. 1 and an operator accessing the machines seat controls provided in the control unit of FIGS. 2-3, in accordance with some embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

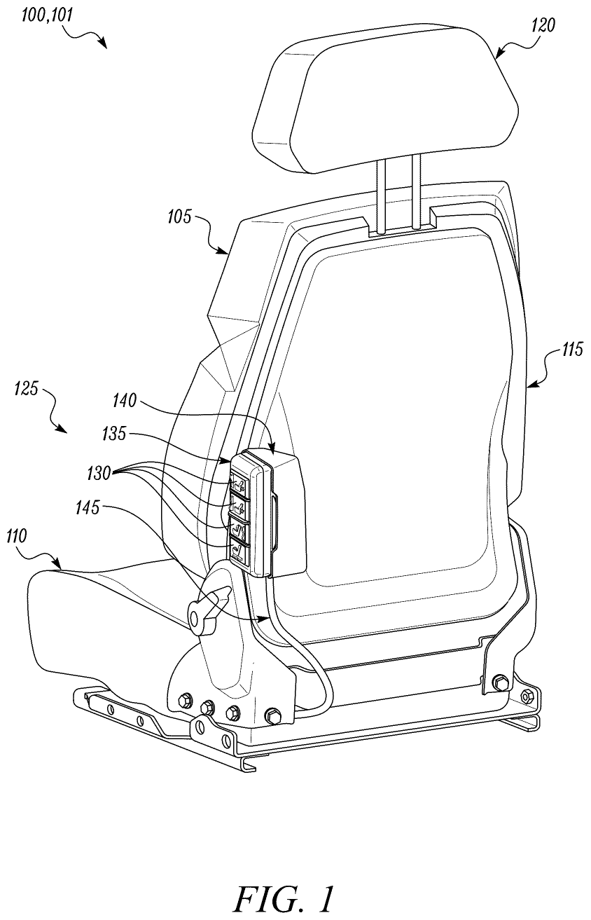

Referring to FIG. 1, an exemplary diagrammatic illustration of an interior 101 of a machine 100 is disclosed. Examples of the machine 100 include, but are not limited to, a haul truck, a water truck, a loader, an excavator, a power shovel, and a tractor. The interior 101 of the machine 100 may include one or more machine seats 105. Each machine seat 105 may include a base assembly 110 for seating an operator of the machine 100, a back rest assembly 115 for providing a back support to the seated operator, and a head rest assembly 120 for supporting a head of the seated operator. The machine 100 may include a system 125 for accessing one or more machine seat controls 130 provided in the machine 100. The machine seat controls 130 may enable the operator seated on the machine seat 105 to configure one or more aspects of the machine seat 105. Examples of the aspects of the machine seat 105 include, but are not limited to, a seat height, an inclination of the back rest assembly 115 with respect to the base assembly 110, a position of one or more cushioning provided in the base assembly, and a position of one or more cushioning provided in the back rest assembly. The system 125 may include a control unit 135 and a holder 140 for accommodating the control unit 135. In some embodiments, the system 125 may also include an extension cable 145 coupled with the control unit 135.

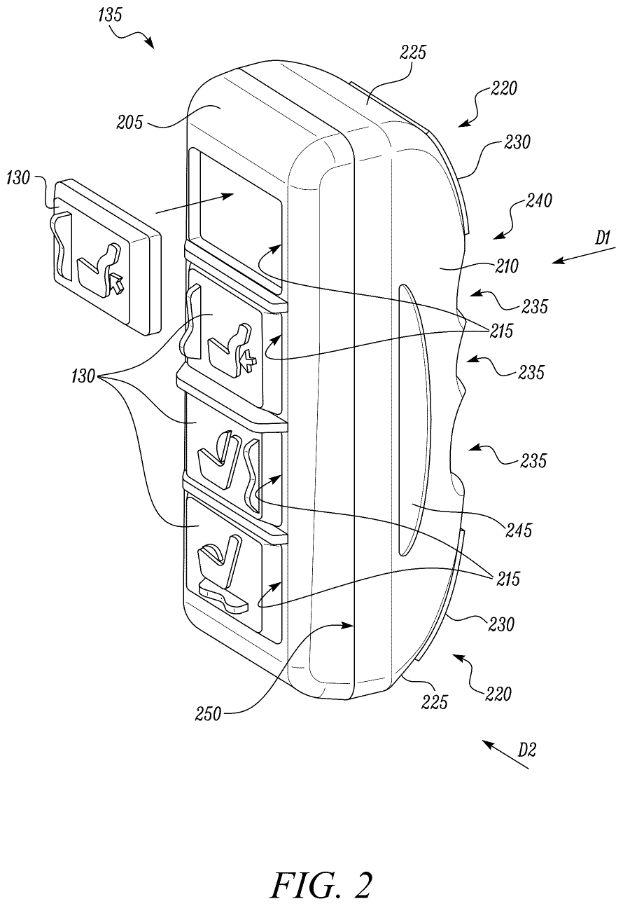

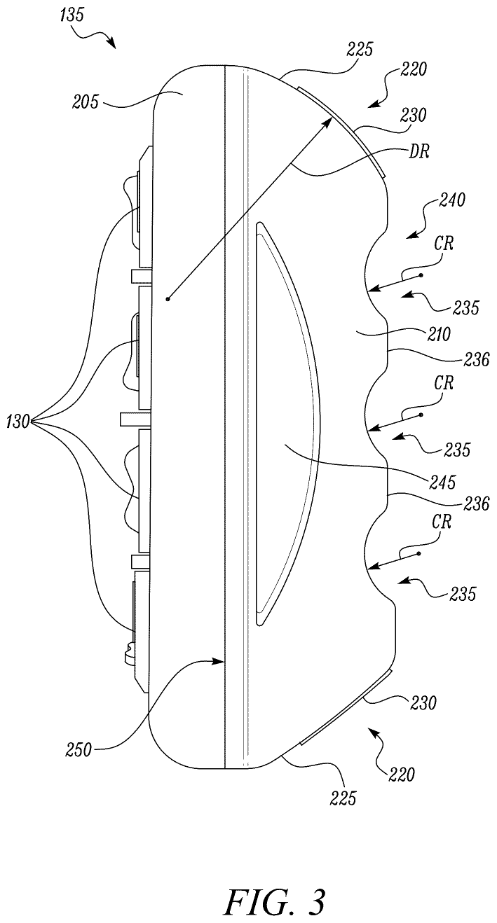

Referring to FIGS. 2-3, exemplary illustrations of the control unit 135 of FIG. 1 are disclosed. The control unit 135 may be configured for machine seat adjustment. In some embodiments, the control unit 135 may include a front casing 205 and a rear casing 210 detachably affixed to the front casing 205. The front casing 205 may include the machine seat controls 130. In some embodiments, the front casing 205 may include one or more openings 215 and the machine seat controls 130 may be provided in the openings 215. It may be appreciated that, in some embodiments, the front casing 205 and the rear casing 210 may correspond to a single unit including a front portion corresponding the front casing 205 having the openings 215 and/or the machine seat controls 130 and a rear portion corresponding to the rear casing 210. In some embodiments, a docking portion 220 of the rear casing 210 may include one or more docking surfaces 225 and one or more casing fastening elements 230 affixed to the docking surfaces 225. Examples of the casing fastening elements 230 include, but are not limited to, hook-and-loop fasteners or magnetic fasteners. For example, the casing fastening element 230 may correspond to the hook-and-loop fastener having fastening loops affixed to the docking surface 225. In some embodiments, the casing fastening element 230 may cover at least a portion of the docking surface 225. In some embodiments, the shape of the casing fastening element 230 may be similar to or different from the shape of the docking surface 225. As an example, the casing fastening element 230 may correspond to a convex shaped magnet.

In some embodiments, the docking surfaces 225 may be convex shaped. For example, the rear casing 210 may include two convex docking surfaces 225. In some embodiments, the docking surfaces 225 may be geometrically same or different with respect to each other. For example, the convex docking surfaces 225 may define the same or different radii DR of curvature respectively. It may be apparent that different shapes of the docking surfaces 225 may also be contemplated. In some embodiments, the rear casing 210 may also include one or more gripping concave grooves 235 for gripping the rear casing 210 and the control unit 135. In some embodiments, the gripping concave grooves 235 may be provided at a rearward portion 240 of the rear casing 210 in a first direction D1. In some embodiments, the rearward portion 240 may be defined opposite to the machine seat controls 130 provided in the front casing 205. In some embodiments, the gripping concave grooves 235 may be provided between the docking surfaces 225. As an example, the rear casing 210 may include two or three gripping concave grooves 235 separating the two convex docking surfaces 225. In some embodiments, the gripping concave grooves 235 may be geometrically same or different with respect to each other. For example, the gripping concave grooves 235 may define the same or different radii CR of curvature respectively. In some embodiments, the gripping concave grooves 235 may also be separated with respect to each other by one or more planar surfaces 236. In some embodiments, the rear casing 210 or a portion of the rear casing 210 may also include one or more undocking concave grooves 245. In some embodiments, the undocking concave grooves 245 may be provided proximate to a forward portion 250 of the rear casing 210 and the front casing 205 or provided between the rearward portion 240 and the forward portion 250. In some embodiments, the undocking concave grooves 245 may be provided in a second direction D2 perpendicular to the first direction D1 of the gripping concave grooves 235.

In some embodiments, the control unit 135 may be coupled with the extension cable 145. In some embodiments, the control unit 135 may be configured to be wireless without the extension cable 145. In some embodiments, the control unit 135 may be Bluetooth®-enabled or include a wireless transmitter (not shown) including, but not limited to, a radio frequency (RF) transmitter to remotely control and/or configure the various aspects of the machine seat 105 via the machine seat controls 130. For example, the control unit 135 may be configured to receive a tactile input corresponding to one of the machine seat controls 130 for modifying the position of the cushioning in the back rest assembly 115 of the machine seat 105. The control unit 135 may then transmit a Bluetooth® or a RF signal to the machine seat 105 in response to receiving the tactile input. The machine seat 105 may be configured to receive the Bluetooth® or the RF signal from the control unit 135 and modify the position of the cushioning of the back rest assembly 115 as required. It may be apparent that, in some embodiments, a duration, a pressure, and/or an intensity of the tactile input provided corresponding to the machine seat controls 130 in the control unit 135 may determine the position of the cushioning of the base assembly 110 and/or the back rest assembly 115 in the machine seat 105. It may also be apparent that, in some embodiments, the machine seat 105 may also be Bluetooth®-enabled or include a wireless receiver (not shown) including, but not limited to, a RF receiver to receive inputs to configure the different aspects of the machine seat 105 from the control unit 135 wirelessly. In addition, it may also be apparent that the machine seat 105 may include one or more hardware, electrical, and/or electronic components (not shown) to change the position of the cushioning in the base assembly 110 and/or the back rest assembly 115 of the machine seat 105 in response to receiving the input from the control unit 135.

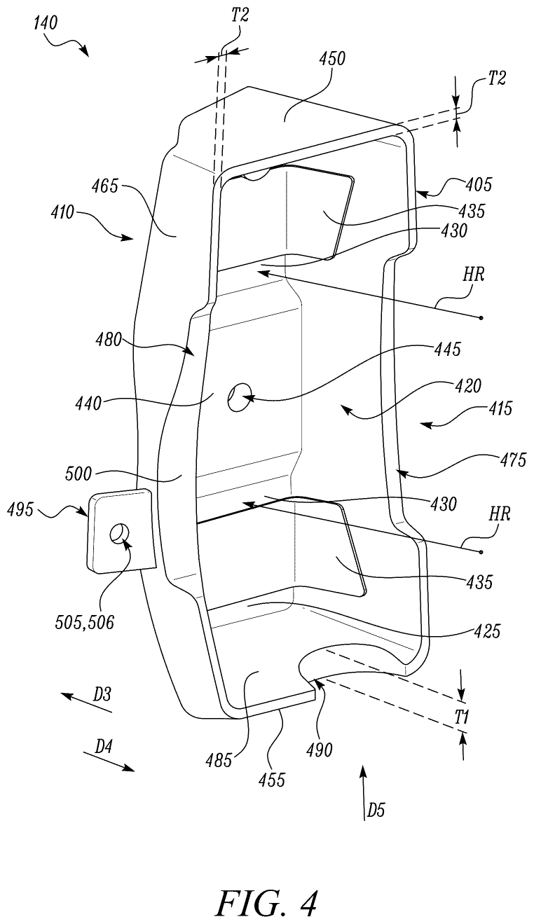

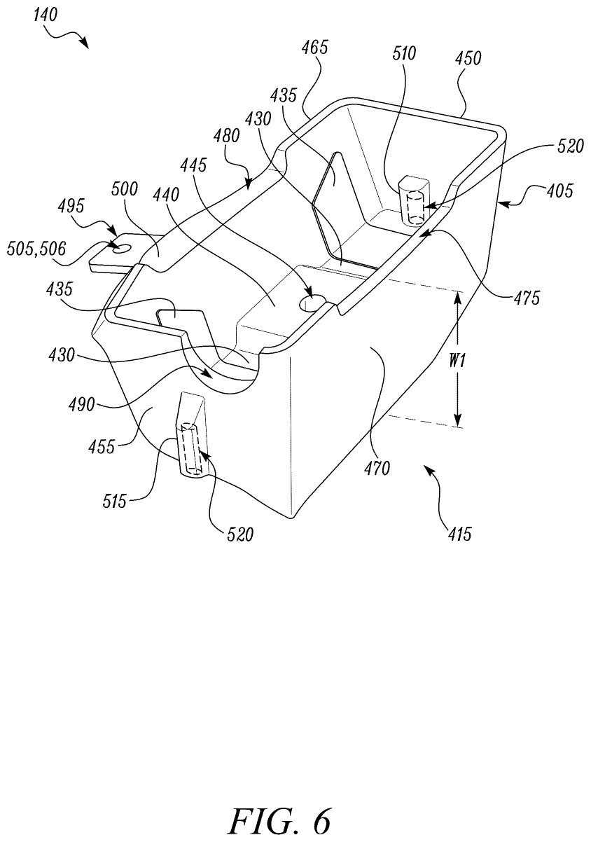

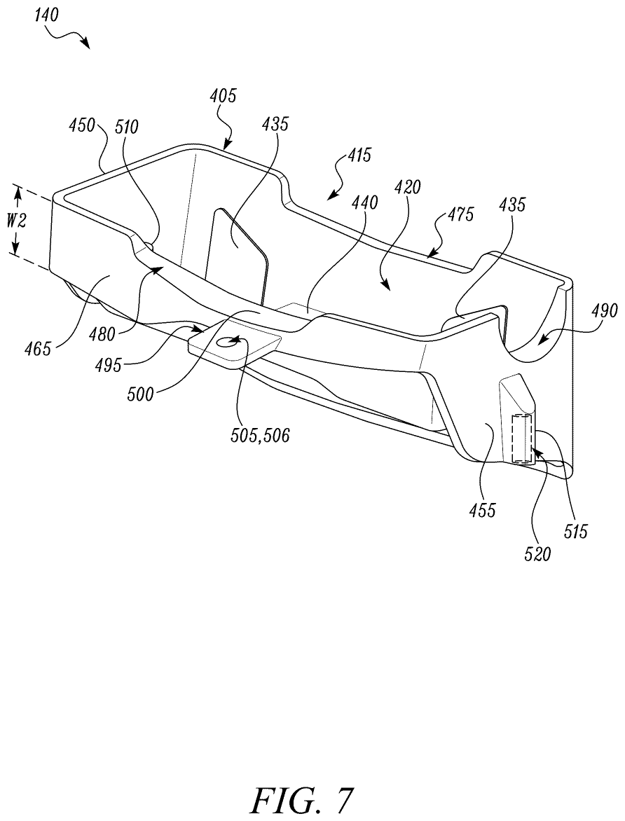

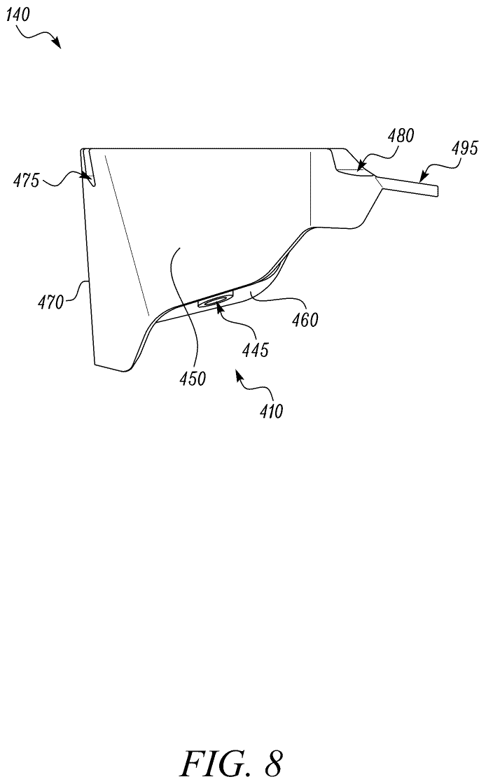

Referring to FIGS. 4-8, exemplary illustrations of the holder 140 for the control unit 135 of FIGS. 2-3 are disclosed. In some embodiments, the holder 140 may be detachably mounted on the machine seat 105. The holder 140 may define a holder body 405 having a closed end 410, an open end 415, and a cavity 420 extending from the closed end 410 to the open end 415. In some embodiments, the cavity 420 may be configured to receive at least a portion of the rear casing 210 of the control unit 135. The cavity 420 may include a rearward portion 425 proximate the closed end 410. The rearward portion 425 may include one or more holding surfaces 430 and one or more holder fastening elements 435 affixed to the holding surfaces 430. Each holder fastening element 435 may be configured for detachable contact with a corresponding fastening element, for example, the casing fastening element 230 provided on the docking portion 220 of rear casing 210 of the control unit 135. Examples of the holder fastening elements 435 include, but are not limited to, hook-and/or-loop fasteners or magnetic fasteners. For example, the holder fastening element 435 may correspond to the hook-and-loop fastener having fastening hooks affixed to the holding surface 430. In some embodiments, the holder fastening element 435 may cover at least a portion of the holding surface 430. In some embodiments, a shape of the holder fastening element 435 may be similar to a shape of the holding surface 430. For example, the holder fastening element 435 may correspond to a concave shaped magnet. In some embodiments, a shape of the holder fastening elements 435 may be same or different from a shape of the holding surfaces 430.

In some embodiments, the holding surfaces 430 may be concave shaped. As an example, in some embodiments, the holding surfaces 430 may correspond to at least two concave holding surfaces 430. In some embodiments, the holding surfaces 430 may be geometrically same or different with respect to each other. For example, the concave holding surfaces 430 may define the same or different radii HR of curvature respectively. It may be apparent that different shapes of each holding surface 430 may also be contemplated. In some embodiments, the rearward portion 425 may also include a planar holding surface 440 separating the two concave holding surfaces 430. In some embodiments, the planar holding surface 440 may be provided with a mounting hole 445. In some embodiments, the holder 140 may be mounted or affixed to the machine seat 105 via the mounting hole 445 and fastening elements (not shown) such as, but not limited to, screws, bolts, and nuts. In some embodiments, the planar holding surface 440 may correspond to an inward protrusion of the rearward portion 425 extending from the closed end 410 to the open end 415 in a direction D3. In some embodiments, the holding surfaces 430 may correspond to depressed regions in the rearward portion 425 separated by the inwardly protruded planar holding surface 440. In some embodiments, the shape of the docking surfaces 225 provided in the rear casing 210 of the control unit 135 may determine the shape of the holding surfaces 430 in the cavity 420. In some embodiments, the docking surface 225 and the holding surface 430 may have complimentary geometric shapes with respect to each other. For example, the convex shape of the docking surfaces 225 of the control unit 135 may be complementary to the concave shape of the holding surfaces 230 of the holder 140.

In some embodiments, the holder 140 may also define a top planar surface 450, a bottom planar surface 455, a rear surface 460, and at least two lateral surfaces 465, 470 enclosing the cavity 420 of the holder 140. The lateral surfaces 465, 470 may extend from the rear surface 460 and from the closed end 410 to the open end 415. The lateral surfaces 465, 470 may also extend from the top planar surface 450 to the bottom planar surface 455. In some embodiments, the rear surface 460 and/or the lateral surfaces 465, 470 may be planar or arcuate. In some embodiments, widths W1, W2 of the lateral surfaces 465, 470 respectively defined between the open end 415 and the closed end 410 may be different with respect to each other. In some embodiments, the rearward portion 425 may include the rear surface 460, the lateral surfaces 465, 470, and an inner cavity surface 485 of the cavity 420 opposite to the rear surface 460 and/or the lateral surfaces 465, 470. In some embodiments, the holding surfaces 430 may correspond to the inner cavity surface 485 opposite to the rear surface 460 and/or the lateral surfaces 465, 470. In some embodiments, the holder fastening elements 435 may be provided on the holding surfaces 430 that are opposite to the rear surface 460. In some embodiments, the holder fastening elements 435 may also extend to the inner cavity surface 485 opposite to the lateral surfaces 465, 470.

In some embodiments, the holder 140 may define access grooves 475, 480 on the lateral surfaces 465, 470. In some embodiments, the access grooves 475, 480 may extend from the lateral surfaces 465, 470 to an inner cavity surface 485 of the cavity 420. In some embodiments, a width of the access grooves 475, 480 defined between the inner cavity surface 485 and the lateral surfaces 465, 470 may be same or different from each other. In some embodiments, the access grooves 475, 480 may also extend at least partially between the top planar surface 450 and the bottom planar surface 455. In some embodiments, the access grooves 475, 480 may also extend at least partially between the open end 415 and the closed end 410 in a direction D4. In some embodiments, the access grooves 475, 480 may provide access to the control unit of FIGS. 2-3 when placed inside the holder 140. In some embodiments, the holder 140 may also define at least one cable groove 490 extending from the bottom planar surface 455 to the inner cavity surface 485 and/or the cavity 420 in a direction D5 that is perpendicular to the direction D3 or D4. In some embodiments, the cable groove 490 may also extend at least partially between open end 415 and the closed end 410 in the direction D4. The cable groove 490 may be configured for routing the extension cable 145 (see FIG. 1) coupled with the control unit 135 and may be positioned below the portion of the rear casing 210 when the control unit 135 is placed inside the cavity 420. In some embodiments, a thickness ‘T’ between the inner cavity surface 485 and the top planar surface 450, the bottom planar surface 455, the rear surface 460, and/or the lateral surfaces 465, 470 may be same or different. For example, in some embodiments, the thickness ‘T1’ between the inner cavity surface 485 and the bottom planar surface 455 may be greater than the thickness ‘T2’ between the inner cavity surface 485 and the top planar surface 450 and/or the at least two lateral surfaces 465, 470.

In some embodiments, the holder 140 may also define at least one mounting protrusion 495 extending away from at least one lateral surface, for example, the lateral surface 465 and the cavity 420. In some embodiments, the mounting protrusion 495 may originate from a groove bottom surface 500 of the access groove, for example, the access groove 480 or below the groove bottom surface 500. In some embodiments, the mounting protrusion 495 may also be inclined at a predefined angle with respect to the groove bottom surface 500 and extend above or below the groove bottom surface 500 towards the open end 415 or the closed end 410. In some embodiments, the mounting protrusion 495 may be planar and include a mounting hole 505. In some embodiments, the cavity 420 may comprise a mounting extension 510 extending from the inner cavity surface 485 into the cavity 420. In some embodiments, the top planar surface 450, the bottom planar surface 455, and/or the rear surface 460 may also include one or more mounting extensions, for example, the mounting extension 515. In some embodiments, the mounting extension 515 may extend outward and away from the bottom planar surface 455 and the cavity 420. In some embodiments, the mounting extensions 510, 515 may be provided with one or more mounting extension holes 520 for mounting the holder 140 to the machine seat 105 (see FIG. 1). In some embodiments the mounting extension holes 520 may be through-holes or configured to be open on one end of the mounting extensions 510, 515 and closed on another end of the mounting extensions 510, 515. In some embodiments, the mounting extensions 510, 515 may be tubular in shape with the mounting extension holes 520 defining the inner diameter of the mounting extensions 510, 515.

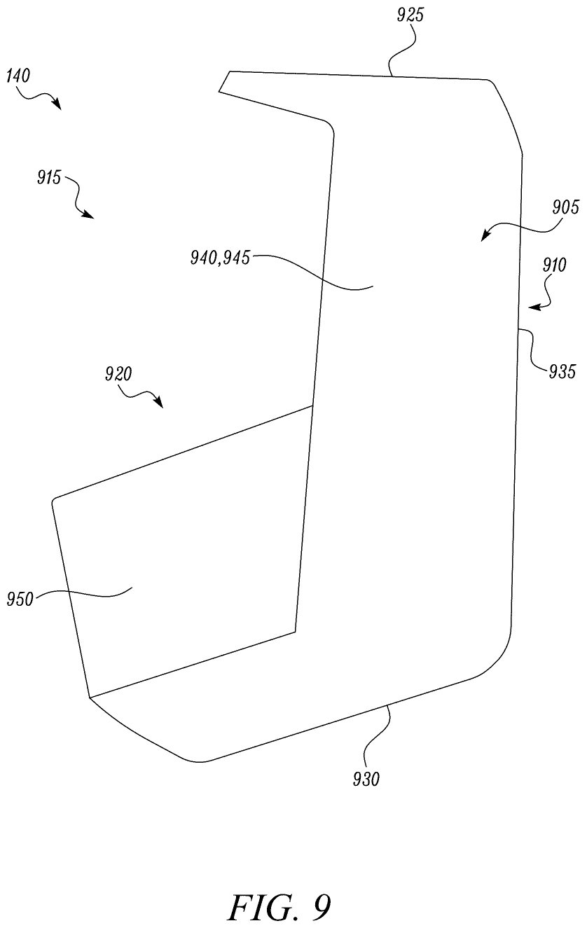

Referring to FIG. 9, an exemplary illustration of the holder 140 in accordance with another embodiment of the present disclosure is disclosed. The holder 140 may define a holder body 905 having the closed end 910, the open end 915, and the cavity 920 extending from the closed end 910 to the open end 915. The cavity 920 of the holder 140 may be configured to receive at least a portion of the rear casing 210 of the control unit 135. In some embodiments, the holder 140 may also define a top planar surface 925, a bottom planar surface 930, a rear surface 935, and at least two lateral surfaces 940, 945 enclosing the cavity 920 of the holder 140. In some embodiments, the holder 140 may also include a front cover 950 proximate the open end 915 and partially enclosing the cavity 920 at the open end 915. The front cover 950 may extend between the at least two lateral surfaces 940, 945 and partially between the bottom planar surface 930, and the top planar surface 925. It may be apparent that, in some embodiments, the cavity 920 of the holder 140 may also include the rearward portion 425 proximate the closed end 410 having the holding surfaces 430 and the holder fastening elements 435 affixed to the holding surfaces 430 similar to the holder 140 of FIGS. 4-8.

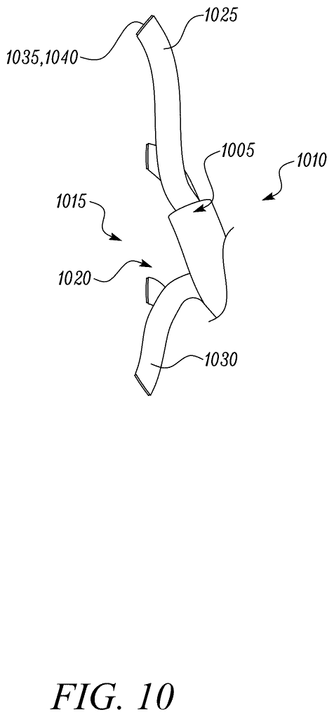

Referring to FIG. 10, an exemplary illustration of the holder 140 in accordance with yet another embodiment of the present disclosure is disclosed. The holder 140 may define a holder body 1005 having the closed end 1010, the open end 1015, and the cavity 1020 extending from the closed end 1010 to the open end 1015. In some embodiments, the holder body 1005 may include at least two holding arms, for example, the holding arms 1025, 1030 extending from the closed end 1010 to the open end 1015. It may be understood that the cavity 1020 of the holder 140 may be defined between the holding arms 1025, 1030 without any enclosing surfaces surrounding the cavity 1020. In some embodiments, at least one holding arm, for example, the holding arm 1025 may include at least one holding surface 1035 proximate the open end 1015 and at least one holder fastening element 1040 affixed to the holding surface 1035. The holder fastening element 1040 may be configured for detachable contact with a corresponding fastening element, for example, the casing fastening element 230 (see FIGS. 2-3) provided on the portion of rear casing 210 (see FIGS. 2-3) of the control unit 135 of FIGS. 2-3. In some embodiments, the closed end 1010 may include one or more mounting means (not shown) for mounting the holder 140 on the machine seat 105 (see FIG. 1).

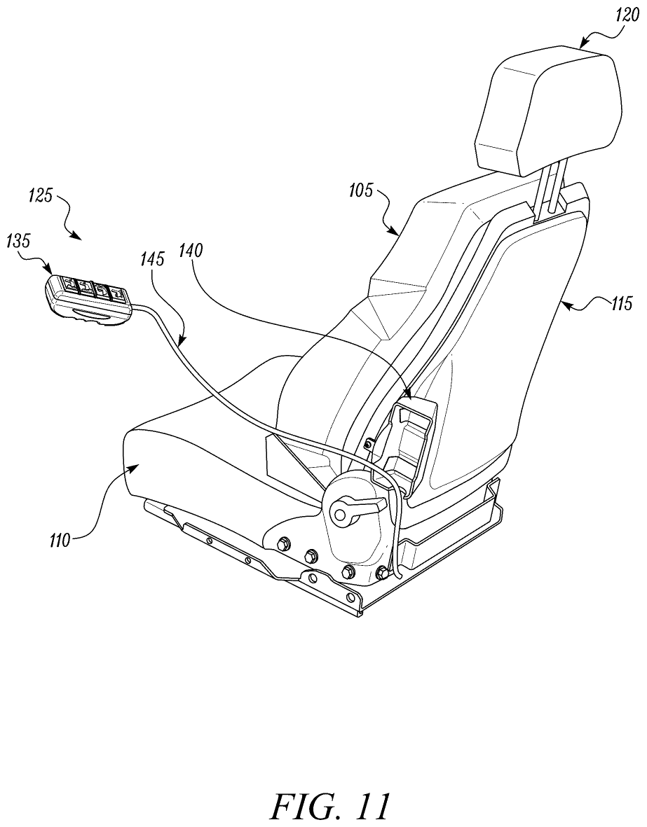

Referring to FIG. 11, an exemplary illustration of the extension cable 145 coupled with the control unit 135 of the system 125 of FIG. 1 is disclosed. The extension cable 145 may be configured to be extensible along with the control unit 135 when the portion of the rear casing 210 of the control unit 135 is removed from the cavity 420 of the holder 140 (see FIG. 1) and the control unit 135 is displaced away from the holder 140. In some embodiments, the extension cable 145 may also be configured to recoil to an initial state of the extension cable 145 prior to the extension and displacement of the control unit 135 from the holder 140. In some embodiments, the system 125 may also include one or more recoiling means (not shown) affixed to the machine seat 105 or below the machine seat 105 to an interior floor provided within the interior 101 of the of the machine 100. In some embodiments, the recoiling means may be affixed to the base assembly 110 of the machine seat 105. It may be understood that the extension cable 145 may include one or more electric wires or circuitry that is in communication with a power source provided in the machine 100 and in communication with the machine seat 105. It may also be understood that the extension cable 145 may be in communication with the base assembly 110, the back rest assembly 115, and the head rest assembly 120 of the machine seat 105. Accordingly, it may be apparent that the extension cable 145 may be in communication with one or more hardware, electrical, and/or electronic means (not shown) provided in the machine seat 105 to configure the different aspects of the machine seat 105. It may also be apparent that, in response to receiving the tactile input received from the control unit 135, the extension cable 145 may provide electrical control signals to the machine seat 105 to configure the different aspects of the machine set 105. For example, the control unit 135 may be configured to receive a tactile input corresponding to one of the machine seat controls 130 for modifying the position of the cushioning in the back rest assembly 115 of the machine seat 105. The control unit 135 may then transmit electrical control signals to the machine seat 105 via the extension cable 145 in response to receiving the tactile input. The machine seat 105 may be configured to receive the electrical control signals from the control unit 135 via the extension cable 145 and modify the position of the cushioning of the back rest assembly 115 as required via the hardware, electrical, and/or electronic means.

### INDUSTRIAL APPLICABILITY

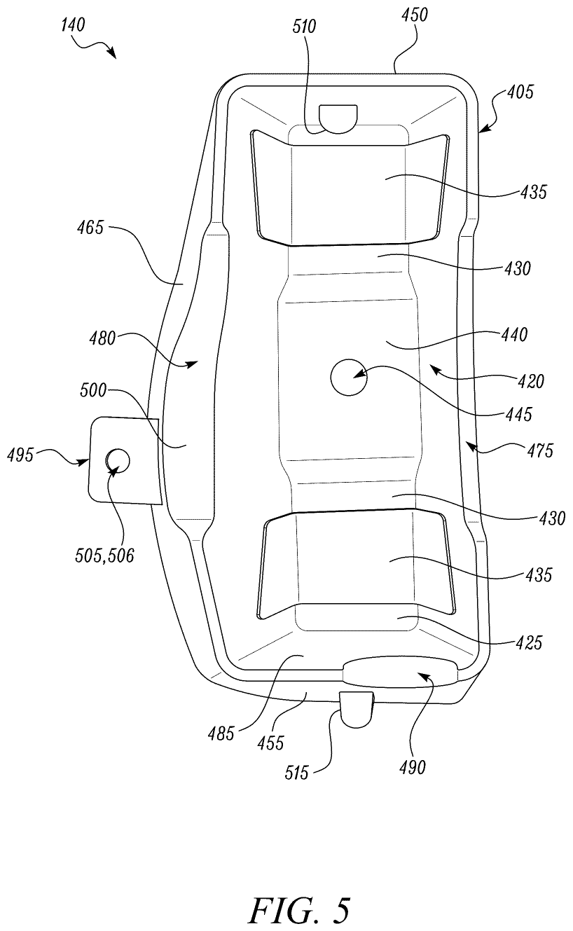

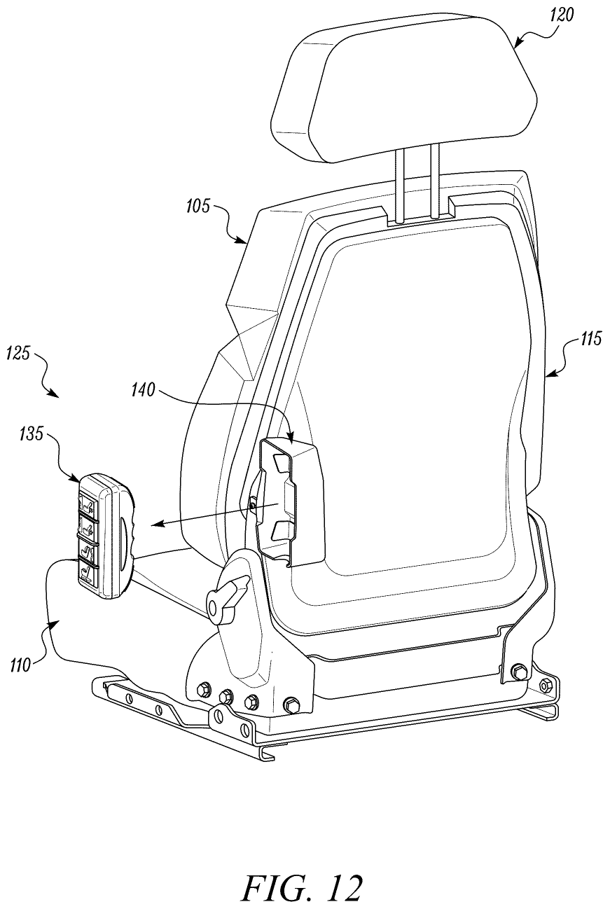

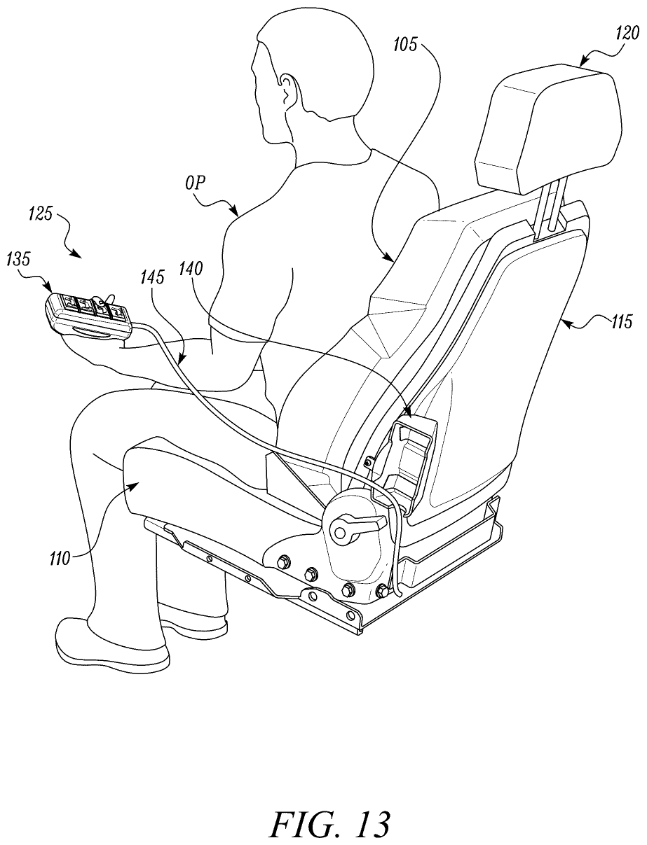

Referring to FIGS. 11-12, an exemplary illustration of an operator ‘OP’ using the system 125 of FIG. 1 for accessing the machine seat controls 130 (see FIG. 1) is disclosed. In some embodiments, system 125 may include the control unit 135 of FIGS. 2-3 having the machine seat controls 130. The control unit 135 with the machine seat controls 130 may be coupled with the extension cable 145 of FIG. 11. In some embodiments, the control unit 135 may be provided in the holder 140 of the FIGS. 4-8 when not in use or operation. In some embodiments, the holder 140 may be mounted on the machine seat 105 (see FIG. 1) via the mounting protrusion 495 (see FIG. 4), the mounting hole 445, and/or the mounting extensions 510, 515 (see FIG. 4) provided in the holder 140. In some embodiments, the holder 140 may be screwed or bolted onto the machine seat 105 via the mounting hole 505 (see FIG. 5) of the mounting protrusion 495 or via the mounting hole 445 provided in the planar holding surface 440 using fastening elements 506 including, but not limited to, a screw or a bolt. In some embodiments, at least a portion of the rear casing 210 (see FIG. 2) of the control unit 135 may be accommodated in the cavity 420 (see FIG. 4) of the holder 140. In some embodiments, the casing fastening elements 230 (see FIG. 2) provided on the rear casing 210 of the control unit 135 may be coupled with the holder fastening elements 435 (see FIG. 4) of the holder 140 to detachably affix the control unit 135 within the cavity 420 of the holder 140.

In some embodiments, the operator ‘OP’ may be seated on the machine seat 105 and may be required to access the machine seat controls 130 provided in the control unit 135 to configure one or more aspects of the machine seat 105. The operator ‘OP’ may then access the control unit 135 via at least one of the access grooves 475, 480 (see FIG. 4) provided in the holder 140. The operator ‘OP’ may then be capable of the detachably removing the control unit 135 from within the cavity 420 of the holder 140 via the undocking concave grooves 245 provided in the control unit 135. The operator ‘OP’ may then be capable of drawing the control unit 135 towards the operator ‘OP’ and away from the holder 140. In some embodiments, the extension cable 145 may extend along with the control unit 135 when the operator ‘OP’ draws the control unit 135 away from the holder 140. The operator ‘OP’ may then be capable of configuring or adjusting the aspects of the machine seat 105 via the machine seat controls 130 provided in the control unit 135. In some embodiments, during operation of the machine seat controls 130, the operator ‘OP’ may be capable of gripping the control unit 135 via the gripping concave grooves 235 provided in the control unit 135. Upon completing the configuration of machine seat controls 130, the operator ‘OP’ may place the control unit 135 back into the cavity 420 of the holder 140. During placement of control unit 135 back into the cavity 420 of the holder 140, the extension cable 145 may recoil automatically to the original position of the extension cable 145 prior to the removal and displacement of the control unit 135 away from the holder 140. Further, upon placement of the control unit 135 back into the cavity 420 of the holder 140, the casing fastening elements 230 provided on the rear casing 210 of the control unit 135 may be affixed to and/or co-operate with the holder fastening elements 435 of the holder 140 and detachably affix the control unit 135 within the cavity 420 of the holder 140.

Accordingly, it may be apparent that the system 125 of FIG. 1 and the mounting arrangements including the control unit 135 of FIGS. 2-3 and the holder 140 of FIGS. 4-10 of the present disclosure may enable the operator ‘OP’ seated on the machine seat 105 to retrieve and operate the machine seat controls 130 in an ergonomically convenient manner. For example, the system 125 and the mounting arrangements 135, 140 of the present disclosure may enable the operator ‘OP’ to conveniently extend the control unit 135 to a desired distance away from the holder 140, grip the control unit 135, view the machine seat controls 130, and operate the machine seat controls 130 from the seated position of the operator ‘OP’. Consequently, the system 125 and the mounting arrangements 135, 140 of the present disclosure may minimize operator error in configuring the different aspects of the machine seat 105 as desired. The system 125 and the mounting arrangements 135, 140 of the present disclosure may also minimize a time and effort required to configure the different aspects of the machine seat 105 via the machine seat controls 130 as desired. In addition, the system 125 and the mounting arrangements 135, 140 of the present disclosure may also ensure that the control unit 135 including the machine seat controls 130 is securely held by the holder 140 and may, thereby, prevent accidental slippage, fall, and/or damage of the control unit 135. In some embodiments, for instances when the control unit 135 is capable of being operated wirelessly, the system 125 and the mounting arrangements 135, 140 of the present disclosure may also enable the system 125 and the mounting arrangements 135, 140 to be positioned and/or affixed at any preferred or desired location or position within the interior 101 of the machine 100 that is convenient to the operator ‘OP’, and thereby facilitating easier and quicker access to the machine seat controls 130.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A system for accessing one or more machine seat controls in a machine, comprising:
a control unit configured for machine seat adjustment, the control unit comprising a front casing and rear casing, the front casing comprising the one or more machine seat controls; and the rear casing detachably affixed to the front casing; and
a holder comprising a body, the body defining a closed end, an open end, and a cavity extending from the closed end to the open end, the cavity configured to receive at least a portion of the rear casing of the control unit; and
an extension cable coupled with the control unit and configured to be extensible along with the control unit when the portion of the rear casing is removed from the cavity and the control unit is displaced away from the holder.

2. The system of claim 1, wherein the portion of the rear casing comprises at least one docking surface and at least one first fastening element affixed to the at least one docking surface, and the cavity comprises a rearward portion proximate the closed end, the rearward portion comprising at least one holding surface and at least one second fastening element affixed to the at least one holding surface and configured for detachable contact with the at least one first fastening element.

3. The system of claim 1, wherein the holder defines at least one cable groove extending at least partially in a direction from the open end to the closed end, the at least one cable groove configured for routing the extension cable and positioned below the portion of the rear casing when placed inside the cavity.

4. The system of claim 1, wherein the extension cable is configured to recoil to an initial state of the extension cable prior to the extension and displacement of the control unit from the holder.

5. A holder for a control unit configured for machine seat adjustment, comprising:
a body defining a closed end, an open end, and a cavity extending from the closed end to the open end, the cavity configured to receive at least a portion of the control unit, the cavity comprising a rearward portion proximate the closed end, the rearward portion comprising at least one holding surface and at least one fastening element affixed to the at least one holding surface and configured for detachable contact with a corresponding fastening element provided on the portion of the control unit.

6. The holder of claim 5, wherein the at least one fastening element and the corresponding fastening element correspond to hook-and-loop fasteners or magnetic fasteners.

7. The holder of claim 5, wherein the at least one holding surface corresponds to at least two concave holding surfaces.

8. The holder of claim 7, wherein the rearward portion comprises a planar holding surface separating the at least two concave holding surfaces.

9. The holder of claim 1, wherein the holder defines a top planar surface, a bottom planar surface, and at least two lateral surfaces extending from the closed end to the open end, the at least two lateral surfaces extending from the top planar surface to the bottom planar surface.

10. The holder of claim 9, wherein the at least two lateral surfaces comprise at least one access groove extending at least partially between the top planar surface and the bottom planar surface and in a direction from the open end towards the closed end.

11. The holder of claim 9, wherein the holder defines at least one protrusion extending away from at least one lateral surface of the at least two lateral surfaces and the cavity, the at least one protrusion originating from a bottom surface of the at least one access groove and including a mounting hole.

12. The holder of claim 9, wherein the top planar surface and the bottom planar surface comprise at least one mounting extension respectively.

13. The holder of claim 9, wherein the bottom planar surface comprises at least one cable groove extending at least partially between the at least two lateral surfaces and in a direction from the open end towards the closed end, the at least one cable groove configured for routing an extension cable associated with the control unit.

14. The holder of claim 5, wherein the holder is detachably mounted on a machine seat.

15. A control unit configured for machine seat adjustment, comprising:
a front casing comprising at least one machine seat control; and
a rear casing detachably affixed to the front casing, wherein a portion of the rear casing is configured to be accommodated in a corresponding cavity of a control unit holder, and
wherein the portion of the rear casing comprises at least one docking surface and at least one fastening element affixed to the at least one docking surface for detachable contact with a corresponding fastening element provided in the cavity of the control unit holder.

16. The control unit of claim 15, wherein the at least one fastening element and the corresponding fastening element correspond to hook-and-loop fasteners or magnetic fasteners.

17. The control unit of claim 15, wherein the at least one docking surface corresponds to at least two convex docking surfaces.

18. The control unit of claim 17, wherein the portion of the rear casing comprises at least one concave groove separating the at least two convex docking surfaces.

19. The control unit of claim 15, comprising an extension cable coupled with the control unit and configured to be extensible along with the control unit when the portion of the rear casing is removed from the cavity and the control unit is displaced away from the holder.

20. The control unit of claim 15, wherein a remaining portion of the rear casing comprises at least one concave groove that is outside of or partially extends into the cavity of the control unit holder.
